(19) United States
(12) Patent Application Publication
(10) Pub. No.: US 2019/0026775 A1
(43) Pub. Date: Jan. 24, 2019

(54) PLACEMENT EXPLORATION

(71) Applicant: Facebook, Inc., Menlo Park, CA (US)

(72) Inventors: Anand Sumatilal Bhalgat, Mountain View, CA (US); Hao Song, Mountain View, CA (US); Ajay Ravindran, Palo Alto, CA (US)

(21) Appl. No.: 15/652,412

(22) Filed: Jul. 18, 2017

(51) Int. Cl. G06Q 30/02

(52) U.S. Cl. CPC G06Q 30/0254; G06Q 30/0275; G06Q 30/0246; G06Q 30/0269; G06Q 30/0261

(57) ABSTRACT

A content delivery system adjusts bids across publishing channels to account for historical ratios that content was targeted to a content item's audience. A content campaign for users of a content delivery system is devised for two or more sponsored content providers. Targeting criteria for the content item is used to define an audience for the content item, and a sample group from that audience is chosen. The ratio of content impressions among the content providers is identified for the sample group among prior content presentations to these users. For the content item, based on the current ratio of presenting content across a secondary publishing channel and a benchmark publishing channel, a channel control factor is adjusted for the secondary publishing channel based on a numerical comparison of these two ratios. This adjusted channel control factor adjusts the bid price per impression for displaying content by the content campaign.

### BACKGROUND

This invention relates generally to advertising, and in particular allocating targeted sponsored content to online users efficiently as they view content from multiple sponsored content providers.

Sponsored content revenue provides an important revenue stream for online content providers. Targeting sponsored content to particular online content publisher users typically generates greater sponsored content revenues for sponsored content providers compared to revenues from broad-based sponsored content because users typically perceive targeted sponsored content as being more relevant. By serving more relevant sponsored content, a sponsored content provider increases the conversion rate of viewers of the sponsored content and improves the experience of users viewing the sponsored content (who prefer to view content reflecting their interests), benefiting both the sponsored content provider and the online content publisher.

Sponsored content providers attempt to optimize content delivery across multiple publishing domains to maximize the available impressions for the content. Traditionally, a sponsored content provider creates separate campaigns for the content in different domains by splitting the sponsored content budget into separate budgets for each separate domain. Each separate campaign may then be operated differently, including different bids, different pacing, and other parameters that may vary for delivery of sponsored content at the different domains. Accordingly, sponsored content providers may inefficiently spend budgets as a result of the split campaigns.

This method of budgeting is often not optimally efficient. Typical placement ranking models across multiple publishing channels are skewed because there is not enough information to allocate budgets efficiently. This means that there is insufficient delivery on a given placement, while another placement may receive more delivery than is effective.

### SUMMARY

Embodiments of the present disclosure enable a content publishing system to set targets for cross-placement delivery of sponsored content to different publishing domains and provide a unified budget and targeting across the different publishing domains. Thus, the content publishing system may provide the sponsored content across multiple publishing domains effectively via one ad campaign and control allocation of the sponsored content at individual placement channels. Impression data for sponsored content impressions is collected across multiple publishing domains. The data relating to each publishing domain is compared with a target number of impressions for that domain. Depending whether the actual number of impressions for the given domain is greater or less than the target number, a control variable is increased or decreased to adjust the likelihood of the advertisement being selected for placement at the publishing domain.

In one embodiment, the campaign specifies a target group of users to receive the sponsored content, for example, as specified by targeting criteria of the campaign. These users have demographic or geographic characteristics that may be responsive to or interested in the sponsored content of the campaign or to whom the campaign wishes to increase views of the sponsored content. To determine the target number of impressions for a secondary publishing channel, the comparative frequency that prior campaigns targeted these users at the secondary publishing channel and at a benchmark publishing channel is determined and used to set the target impressions for that secondary channel. In one embodiment, a sample of the target users is identified. In another embodiment, all target users are evaluated. For the target users (or a sample thereof) an impression history of each user in this group is determined. The impression history is filtered for campaigns that targeted the target users (or the sample thereof) at the benchmark publishing channel and the given publishing channel. Thus, this history is determined for campaigns that target sponsored content placements in both domains. This impression history is used to determine an impression ratio k for each pair of domains representing a target ratio for the current campaign to each publishing channel relative to the benchmark publishing channel. These impression ratios are then used to adjust a channel control variable L for a secondary publishing channel i. The channel control variable thus controls the amount of placements in other secondary publishing channel with respect to the placements in the benchmark publishing channel. The target number of impressions for a secondary publishing channel is determined by multiplying the observed number of impression for the campaign by k. The actual impressions relative to the target impressions is used to adjust the channel control variable L upwards to increase the actual impressions or downwards to decrease the impressions.

Thus, in one example a unified campaign may place bids for a plurality of channels. Bids for a given channel for a particular campaign may be given in such a unified campaign by adjusting a bid for the campaign based on each channel's channel control variable. The bid may also be determined based on a bid for the campaign and expected conversion rate, along with other factors for the campaign, such as pacing. This permits the single expected conversion rate, user the following formula:

In one embodiment, a single campaign may adjust pacing for the campaign as a whole and bids for a plurality of individual channels, permitting this single campaign to better account for impressions across channels than an advertiser specifying different independent campaigns for different channels. In addition, by adjusting the channel factor to encourage a ratio similar to other campaigns, the campaign may be more likely to continue to serve advertisements to channels that otherwise initially appeared to have a low conversion rate. In this way, this approach may also encourage “exploration” of the channels by targeting similar impression ratios to other campaigns.

### BRIEF DESCRIPTION OF THE DRAWINGS

FIG. 1 (FIG. 1) is a high-level block diagram of a system environment for a content publishing system, according to one embodiment.

FIG. 2 is an example block diagram of an architecture of the content publishing system, according to one embodiment.

FIG. 3 is a flowchart illustrating a process of adjusting channel control factors for determining a bid at a secondary publishing channel, according to one embodiment.

FIG. 4 is a set of charts illustrating the temporal effects of the process of placement exploration.

The figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

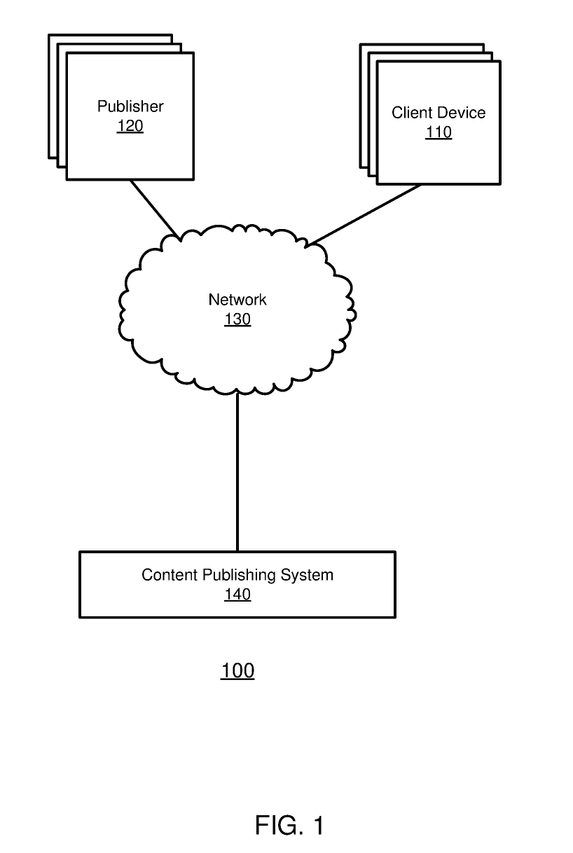

FIG. 1 is a high-level block diagram for a system 100 that delivers advertisements to users, according to one embodiment. In the embodiment of FIG. 1, the system environment 100 includes one or more client devices 110, one or more content publishers 120, a network 130 and a content publishing system 140. In alternative configurations, different and/or additional components may be included in the system environment 100. The embodiments described herein can be adapted to online systems that are not social networking systems.

In the embodiment of the system environment in FIG. 1, a content publishing system 140 is a sponsored content platform that selects sponsored content with different online content and places the selected sponsored content in sponsored content slots for presentation to users on client devices 110. In one embodiment, the content publishing system 140 submits sponsored content to content publishers 120 for display. Content publishers 120 include search engines, social networking systems, news distribution systems, online forums, and any other electronic systems or webpage hosting platforms that provide sponsored content to users and gather ad impression data from users. Rather than submitting sponsored content to the content publishers 120, a client device 110 accessing the content publisher 120 may follow a link or other reference to retrieve content from the content publishing system 140. As an additional example of a content publisher 120, applications that execute on the client device 110 may also retrieve content from the content publishing system for display to the user. These applications may provide an additional content slots for presentation to users of the client devices 110.

As discussed more fully below, the various publishers 120 may constitute multiple publishing channels through which sponsored content may be delivered to users from the content publishing system 140. A publishing channel represents a set of publishers 120 for which content is typically selected together and for which the same content campaigns direct content. In some cases, an individual publisher 120 may constitute a publishing channel, or a plurality of publishers may together constitute a publishing channel. For example, a set of five publishers 120 may all be grouped together as a publishing channel. Typically, publishers 120 may be grouped together as publishing channels based on the type of publisher 120. For example, one publishing channel may be publishers 120 that provide web pages to users, while another publishing channel includes mobile device applications.

The content publishing system 140 may manage selection of content to the publishing channels, for example through an auction process. For a given campaign, the content publishing system 140 manages delivery of content in the campaign across the publishing channels to permit a campaign to target the various publishing channels in a single campaign. For each channel, a channel control variable adjusts bids for the campaign for placement at that channel. When actual delivery of content to publishing channels is above or below a specified ratio of delivery to a benchmark publishing channel, the channel control variable is adjusted for that campaign to increase or decrease the likelihood that subsequent placements of the campaign re-align the actual delivery to the specified ratio.

Users access a network 130 using their client devices 110. A client device is defined to be any type of computing device that is capable of connecting to an internet network. A client device 110 can send data to and receive data from other devices on the network 130. A user can use his client device 110 to access content posted on a webpage using the network 130. An example of a content publisher is a news website. When the client device connects to the publisher's web page, the publisher requests sponsored content from the content publishing system 140. When users receive online content on the client device 110, the client device 110 may contact the content publishing system 140 responsive to a tracking cookie in the publisher's advertisement slot. The content publishing system 140 may interrogate the client device 110 to receive the cookie and attempt to identify the user or client device 110 in a user database. The content publishing system selects content to display on the publisher's web page.

A client device 110 is a computing device that is capable of receiving user input as well as transmitting and/or receiving online data via the network 130. In the embodiment shown by FIG. 1, one or more client devices 110 can communicate within the network 130 and interact with the publishers to receive and download sponsored content from the publishers 120 and provide ad impression data and client device information to the content publishing system 140. For example, a client device 110 may request a publisher 120 to download sponsored content on a webpage of that publisher. The client devices 110 also interact with the content publishing system 140 to provide user data to the system.

In one embodiment, a client device 110 can be a conventional computer system, such as a desktop or a laptop computer. In another embodiment, a user device 110 can be a mobile telephone, a smartphone or a personal digital assistant (PDA). In one embodiment, the user device 110 interacts with other components in the network 130 through an application programming interface (API) running on a native operating system of the client device 110, such as IOS® or ANDROID™.

The content publishing system 140 shown in FIG. 1 allows publishers 120 to identify individual users of the content publishing system 140. For example, the online cookie that tracks an online user may indicate the user has a logged-in account to the content publishing system 140, which helps identify the online user. For another example, the tracking cookie via which sponsored content impression data is received is a tracking cookie implemented by the content publishing system 140, which helps identify the online user. The content publishing system 140 may include a user database that stores user data of its known registered users. The stored user data helps identify the registered users and provides user feature data. In one embodiment, example data includes profile information provided by users on profile pages like demographical information such as age, gender, email address, mobile contact information, education history, and work experience. The user data may also include geographical location, such as information about the physical location where a user is accessing the client device 110. The geographical information can be acquired, for example, by the IP address tracked by the content publishing system 140. In another embodiment, user data stored in the user database in the content publishing system 140 can be analyzed to provide other information such as hobbies, personal information, or specific products. The analyzed data can be acquired by tracking user behavior on the content publishing system 140 or by other identification methods.

These components described above communicate and interact with each other within the network 130. The network 130 may comprise any combination of local area and/or wide area networks, using both wired and/or wireless communication systems. In one embodiment, the network 130 uses standard communications technologies and/or protocols such as Ethernet, 802.11, worldwide interoperability for microwave access (WiMAX), 3G, 4G, code division multiple access (CDMA), etc. Example communication protocols include transmission control protocol/Internet protocol (TCP/IP), hypertext transport protocol (HTTP), file transfer protocol (FTP) and multiprotocol label switching (MPLS). Data exchanged over the network 130 can be represented for example, in the format of hypertext markup language (HTML) or extensible markup language (XML). Additional technologies may also be used in the network 130.

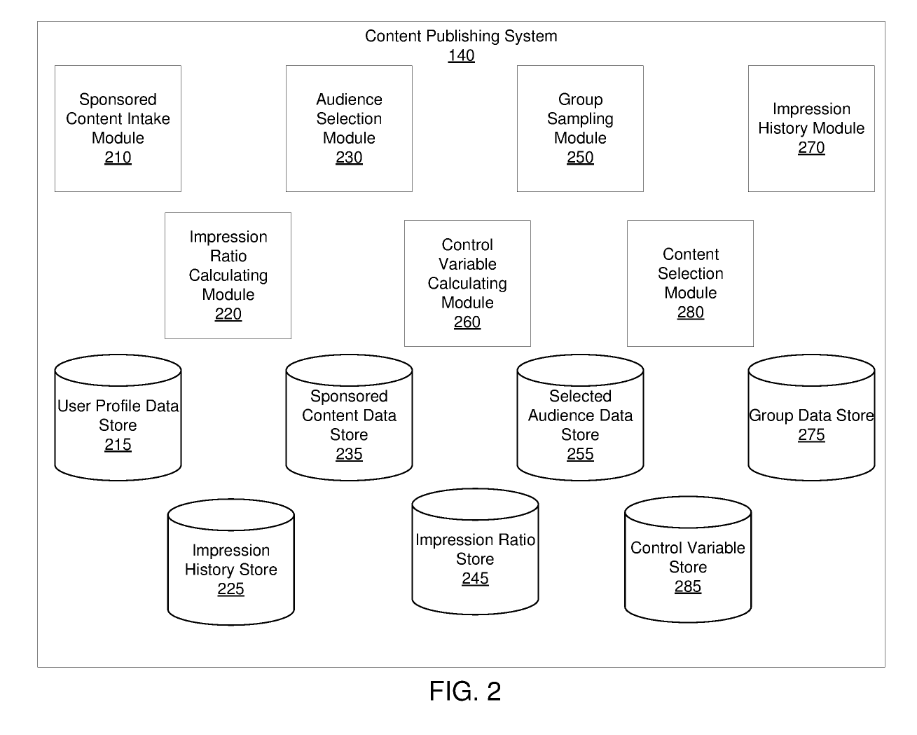

FIG. 2 is an example block diagram of the architecture of the content publishing system 140, according to one embodiment. In the embodiment of FIG. 2, content publishing system includes an sponsored content intake module 210, an impression ratio calculating module 220, an audience selection module 230, a group sampling module 250, a control variable calculating module 260, an impression history module 270, a content selection module 280, a user profile data store 215, an impression history store 225, an sponsored content data store 235, an impression ratio store 245, a selected audience data store 255, a group data store 275, and a control variable store 285. In other embodiments, the content publishing system 140 may include additional, fewer, or different components for various applications. Conventional components such as network interfaces, security functions, load balancers, failover servers, management and network operations consoles, and the like are not shown so as to not obscure the details of the system architecture.

Each user of the content publishing system 140 is associated with a user profile, which is stored in the user profile store 215. The user profile store 215 stores user feature data, such as demographic and geographical information, that describes characteristics of users. In one embodiment, the user feature data can be extracted from the content publishing system 140. In other embodiments, user features may be identified from other data sources, such as via an advertising pixel that tracks user behavior across many web pages, and the user features may thus include inferred data or characteristics of the users from user behavior. In one embodiment, the geographical information may indicate the location where a user is accessing the client device 110. In another embodiment, the geographical information may indicate the locations the user has visited. For example, the geographical information may indicate that the current location of the user is London, the user has visited Canada and China, and was born in California, US. The demographic information of a user may include age, gender, hobbies and interests, education history, work experience, and other personal information. For example, demographic information may show, for the same given user, that he is a 17-year old boy who loves playing tennis and collecting different brands of sneakers. This user feature data is useful for the content publishing system 140 to understand characteristics of a user for the purpose of delivering targeted content. For example, a sneaker advertiser selling sneakers in London may intend to target the user mentioned in the above example. This advertiser may request reports for online users whom are interested in buying sneakers in London.

While user profiles in the user profile store 215 are frequently associated with individuals, allowing individuals to interact with each other via the content publishing system, user profiles may also be stored for entities such as businesses or organizations. Storing profiles allows entities to establish presences on the content publishing system 140 for connecting and exchanging content with other social networking system users. An entity may post information about itself, about its products or provide other information to users of the social networking system using a brand page associated with the entity's user profile. Other users of the social networking system may connect to the brand page to receive information posted to the brand page or to receive information from the brand page. A user profile associated with the brand page may include information about the entity itself, providing users with background or informational data about the entity.

The audience selection module 230 uses the demographic and geographical information from the user profile data store to select a target audience. A target audience is a set of users that a sponsored content provider believes is the desired audience for presentation of the content based on the demographic and geographic profile of the users in that audience. For example, a provider wishing to publish content related to a brand of running shoes targets online system users subscribed to the provider's online system page. The provider may also target online system users subscribed into online system discussion groups related to running. In addition, online system users who regularly post links to running-related content may also be targeted by the provider Geographic information used to target users may include whether the online system users live in the geographical vicinity of stores selling running shoes, or whether they live in areas where running is a popular activity. In some embodiments, the selected audience has a threshold affinity rating for a product advertised by the sponsored content provider. Once the audience is selected, it is stored in the selected audience data store 255.

The group sampling module 250 may identify and select a subset of users from the selected audience data store 255. This group is used to calculate a target impression ratio for each publishing channel. The group is chosen to be a subset of the targeted audience to reduce computational complexity. In one embodiment, the subset of users is chosen by random sampling from the audience of users that meet the targeting criteria for the campaign. The sample of the audience selected by the group sampling module 250 is large enough to be a representative sample of the targeted audience.

The impression history module 270 identifies an impression history for the sample group created by the group sampling module 250. An impression history comprises the total number of sponsored content impressions provided to users in the audience from each publisher 120 and from the content publishing system 140. In this example, the content publishing system 140 also provides publishing of content items and may itself be a publisher 120. The impression history module 270 creates the impression history by accessing the advertising data store 235 and aggregating the impression data for ads targeted to each of the users in the sample group. When this impression history is created, it is stored in the impression history store 225.

The impression ratio is calculated by the impression ratio calculating module 220. The impression ratio may be determined between each publishing channel and a benchmark publisher. The benchmark publishing channel may be common across a group of publishing channels, and in one embodiment the benchmark publishing channel is the content publishing system 140 when operating as a content publisher 120. The ratio for the benchmark publisher may be treated as 1. Each other publishing channel, termed a “secondary publishing channel,” is measured against the benchmark publisher. The impression ratio for a secondary publishing channel is calculated by identifying the number of impressions for the audience (e.g., as measured by the sample group) compared to the number of impressions for the benchmark publishing channel.

Two impression ratios may be calculated: a target impression ratio and a current impression ratio. The target impression ratio represents the desired impression ratio for a content campaign, and the impressions identified for each publisher may be the number of impressions from prior content campaigns that were shown to users in the audience. In this way, the taret impression ratio for each publishing channel may be determined based on the previous impressions by campaigns to guide the expected ratio of impressions for this content campaign. In some embodiments, the previous campaigns for evaluating the target impression ratio are limited to those campaigns from the same content provider that provided the current campaign. The current impression ratio is the ratio that the current content item of the campaign is presented to users of the audience at the secondary publishing channel relative to the benchmark publishing channel. This impression ratio is stored in the impression ratio store 245.

The control variable calculating module 260 takes the impression ratio from the impression ratio store 245 and uses it to calculate the channel control variable L. The channel control variable acts as a feedback mechanism that dynamically adjusts the bid for a content channel to affect the number of content impressions from content served by the publishing channels. The channel control variable is increased if the target impression ratio is greater than the current impression ratio. It is decreased if the target impression ratio exceeds the current impression ratio. The calculated control variable is stored in the control variable store 285.

The content selection module 280 determines the content that is displayed to users of the content publishing system. The content selection module 280 receives a request for content from a publishing channel or from a client device for a given user requesting content. The request for content may be considered an “impression opportunity” from the perspective of content items that may be selected and presented to the user. The content selection module 280 determines which content items the user is eligible to receive. For example, which content items specify the user as a part of the content item's desired audience. For each of these content items, the content selection module 280 may score and rank the content items to determine which to present to the user. In this ranking, the content items may be associated with a value, such as a bid value, for use in an auction in selecting the content items for presentation. The content selection module thus selects and sends the content items for display to the user.

For content items targeting multiple publishing channels, the content selection module determines a bid price for content to be delivered to the publishing channel associated with the request for content for the user. This bid may use the channel control variable to adjust a bid for that user at that publishing channel. In various embodiments, various factors may be included in determining a bid value for an impression opportunity. In one example, the bid is determined by the formula:

bid i=λᵢ×γ×b×eCVN

In the above formula, i refers to the bid price to place an advertisement, λᵢ is the channel control variable, γ is a pacing variable, b is the bid value for the campaign, and eCVN is the expected conversion rate of a user with respect to the sponsored content at that channel. Other or fewer factors may be used in varying embodiments, for example to omit the pacing variable, or to include other means for adjusting a bid of a campaign.

In this example, the control variable adjusts a content provider's bid on a per-channel basis to adjust for impression frequency across the channels, and to permit the campaign to use other unified bidding characteristics, such as pacing and bid value (for a conversion) across multiple channels. The expected conversion rate is determined based on prior user and content interactions from the content publishing system 140. The content publishing system 140 may include predictive computer models that learn likely interaction and conversion rates of users with respect to content, and may include characteristics of the publisher or publishing channel as features in applying the predictive model to determine a predicted conversion rate of the user. The pacing variable γ may be adjusted for a campaign based on the spending rate for the campaign relative to a target spend (or budget) for the campaign within a time frame. For example, when the bid is resulting in spending above a desired rate, the pacing variable may be adjusted downwards to reduce the bid value (and thereby the subsequent spend) of the campaign so that the spending does not outpace the target spend before the time frame ends. The bid i may thus be calculated for each content campaign competing for the impression opportunity, and the publishing channel may select content by ranking or conducting an auction among those competing campaigns.

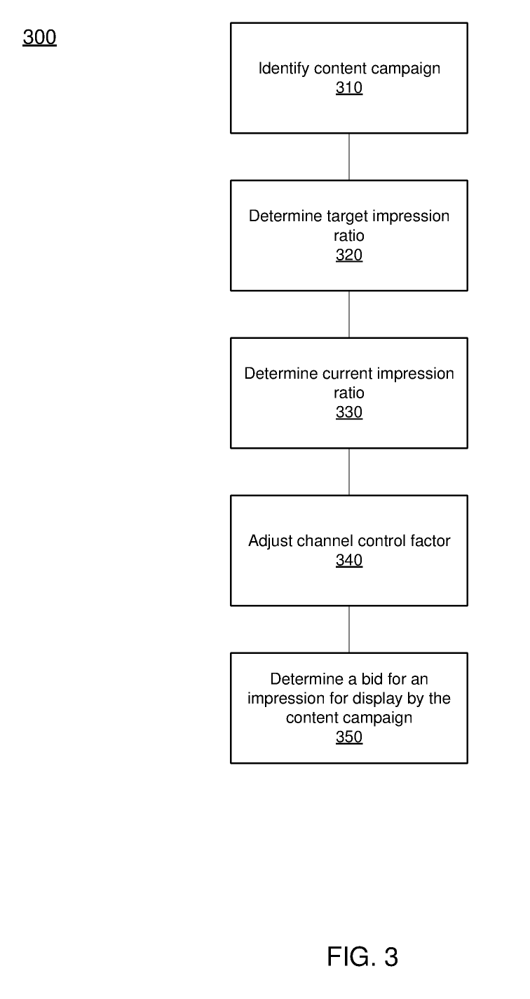

FIG. 3 is a flowchart illustrating a process of adjusting channel control factors for determining a bid at a secondary publishing channel, according to one embodiment. First, a content campaign is identified 310 specifying two or more publishing channels. This identification and process may be performed to adjust the channel control factor for a publishing channel, and may be performed at specified times or conditions, such as periodically (such as every day), when a threshold number of impressions for the campaign have occurred, or when the campaign has spent a portion of its budget for a time frame. Though described below with respect to an individual secondary publishing channel, the process may be performed simultaneously for all secondary publishing channels designated by the campaign. Content from the campaign is displayed in each publishing channel and interactions by users with the content is processed by the impression history module 270 and stored in the impression history store 225.

After the content campaign is identified 310, a target impression ratio is calculated 320. First, a sample group is made from the target audience using the group sampling module 250. The impression history of each user, including the impression history for the secondary publishing channel and benchmark publishing channel is retreived from the impression history store 225. These histories are then aggregated to form an impression history for the group for each publishing channel. From these aggregated histories, the target impression ratio k for the group is determined by the impression ratio calculating module 220.

Next, the current impression ratio for users viewing the campaign content for the secondary and benchmark publishing channels is calculated 330. In one embodiment, for example, two publishing channels are being compared. The target impression ratio for the campaign is determining the impression ratio between placements to the secondary publishing channel and placements to the benchmark publishing channel.

The channel control factor λᵢ is then adjusted 340. The channel control factor is increased or decreased according to whether the actual impression ratio exceeds or falls short of the target impression ratio determined for all users. As an example, if the target ratio for the benchmark compared to the secondary publishing channel is 10:7, but the actual ratio were 10:3, the channel control factor would be increased for the secondary publishing channel to increase the likelihood of future content selection to be placed at the secondary publishing channel because the actual impression ratio is lower than the target impression ratio with respect to the secondary publishing channel.

Finally, a bid price is determined 350 based on the changed channel control factor as discussed above. Thus, a single campaign may adjust pacing for the campaign as a whole and bids for a plurality of individual channels, permitting this single campaign to better account for impressions across channels than an advertiser specifying different independent campaigns for different channels.

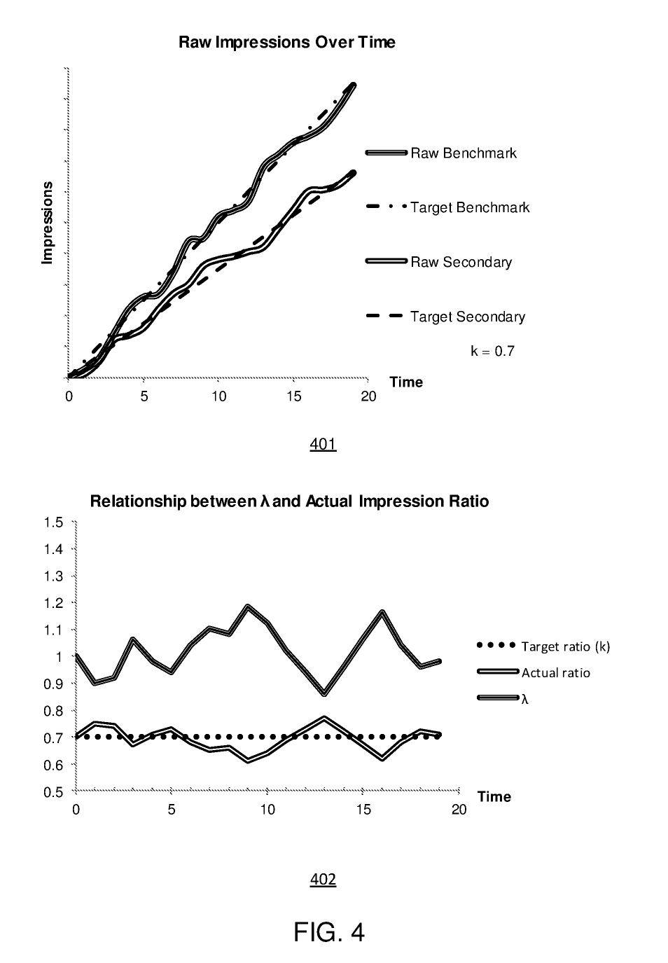

FIG. 4 shows two plots describing how the impression ratio k and the control variable λᵢ affect the number of impressions of a given publisher over time. The impressions graph 401 shows the number of impressions over time of the benchmark publishing channel of the content publishing system and the number of impressions of the secondary publishing channel. The target ratio in this graph is set to 0.7, which means that the publisher is targeted to receive 70% of the impressions of the target domain. The dotted lines show the target number of impressions of each publishing channel, while the solid lines show the actual number of impressions per publishing channel. As the actual impression ratio fluctuates, the control factor for the secondary publishing channel is adjusted and results in the number of actual impressions for the secondary publishing channel tracking more closely to a target number of impressions (based on the target ratio). When the actual number of impressions exceeds the target number of impressions for the secondary publishing channel (e.g., based on the actual impression ratio and target impression ratio), the channel control factor is adjusted downward so that the actual number of impressions will increase more slowly. Conversely, when the actual number of impressions is less than the target number of impressions, the channel control factor is increased. The channel control variable graph 402 illustrates how the channel control variable may be adjusted over time according to the actual and target impression ratios shown in the impressions graph 401. In this example, the channel control factor may be 1 when the secondary publishing channel should be promoted equally to the benchmark publishing channel. When the channel control factor is above 1, it increases the likelihood that the content is selected for the secondary publishing channel and conversely when the channel control factor is below 1, it decreases the likelihood that the content is selected for the secondary publishing channel.

### CONCLUSION

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments of the invention may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A method comprising:
identifying a content campaign for a primary publishing channel and a secondary publishing channel, the content campaign specifying a set of target users eligible to receive content associated with the content campaign;
determining, a target impression ratio for the primary and secondary publishing channels based on impressions by other content campaigns to the set of target users in the primary publishing channel and the secondary publishing channel;
determining a current impression ratio for the content campaign for impressions at the primary publishing channel and the secondary publishing channel;
adjusting a channel control factor for the secondary publishing channel based on the current impression ratio and the target impression ratio; and
determining a bid for an impression for the content campaign to display the content to a viewing user in the set of target users in the secondary publishing channel by modifying a bid for the content campaign by the channel control factor.

2. The method of claim 1, wherein the impression ratios are updated on a temporally periodic basis.

3. The method of claim 1, wherein the bid is determined for content sent to both the primary publishing channel and the secondary publishing channel.

4. The method of claim 1, wherein the primary publishing channel is an advertising network.

5. The method of claim 1, wherein the bid is determined by computing a mathematical formula that includes arguments from a group consisting of a bid price, the channel control factor, a bid pacing value, and an expected conversion rate.

6. The method of claim 5, wherein the bid pacing value is the same for both publishing channels.

7. The method of claim 5, wherein a conversion comprises interactions from a group consisting of clicks and views.

8. The method of claim 5, wherein the bid price is the same for both publishing channels.

9. The method of claim 1, wherein the set of target users comprises users satisfying specific geographical and demographic characteristics.

10. The method of claim 1, wherein determining the target impression ration includes sampling users from the set of target users.

11. The method of claim 10, wherein determining the target impression ratio includes numerically comparing impression data among the users, the impression data comprising user interactions with content from the first and second publishers.

12. The method of claim 1, wherein determining a current impression ratio includes aggregating all user impressions associated with content published by the first and second publishers.

13. The method of claim 1, wherein adjusting the channel control factor comprises increasing the channel control factor if the current impression ratio is less than the target impression ratio and decreasing the channel control factor if the current impression ratio is greater than the target impression ratio.

14. A computer program product comprising a non-transitory computer readable storage medium having instructions encoded thereon that, when executed by a processor, cause the processor to:
identify a content campaign for a primary publishing channel and a secondary publishing channel, the content campaign specifying a set of target users eligible to receive content associated with the content campaign;
determine, a target impression ratio for the primary and secondary publishing channels based on impressions by other content campaigns to the set of target users in the primary publishing channel and the secondary publishing channel;
determine a current impression ratio for the content campaign for impressions at the primary publishing channel and the secondary publishing channel;
adjust a channel control factor for the secondary publishing channel based on the current impression ratio and the target impression ratio; and
determine a bid for an impression for the content campaign to display the content to a viewing user in the set of target users in the secondary publishing channel by modifying a bid for the content campaign by the channel control factor.

15. The computer program product of claim 14, wherein the impression ratios are updated on a temporally periodic basis.

16. The computer program product of claim 14, wherein the bid is determined for content sent to both the primary publishing channel and the secondary publishing channel.

17. The computer program product of claim 14, wherein the primary publishing channel is an advertising network.

18. The computer program product of claim 14, wherein the bid is determined by computing a mathematical formula that includes arguments from a group consisting of a bid price, the channel control factor, a bid pacing value, and an expected conversion rate.

19. The computer program product of claim 18, wherein the bid pacing value is the same for both publishing channels.

20. The computer program product of claim 18, wherein a conversion comprises interactions from a group consisting of clicks and views.
